(19) United States
(12) Patent Application Publication
(10) Pub. No.: US 2025/0205940 A1
(43) Pub. Date: Jun. 26, 2025

(54) APPARATUS FOR COMPRESSION MOULDING CONCAVE OBJECTS

(71) Applicant: SACMI COOPERATIVA MECCANICI IMOLA SOCIETA` COOPERATIVA, IMOLA (BOLOGNA) (IT)

(72) Inventors: GIANLUCA ALDIGERI, IMOLA (BOLOGNA) (IT); DAVIDE BALDISSERRI, IMOLA (BOLOGNA) (IT); MATTEO FAZZIANI, IMOLA (BOLOGNA) (IT)

(21) Appl. No.: 18/846,887

(22) PCT Filed: May 3, 2023
(86) PCT No.: PCT/IB2023/054598

§ 371 Date: Sep. 13, 2024

(30) Foreign Application Priority Data
May 4, 2022 (IT) 102022000009008

(51) Int. Cl. B29C 43/34; B29C 43/02; B29C 43/52

(52) U.S. Cl. CPC B29C 43/34; B29C 43/02; B29C 43/52; B29C 2043/345

(57) ABSTRACT

An apparatus that includes a dispensing device for dispensing at least one polymeric material, a severing element for severing a dose of polymeric material from the polymeric material dispensed by the dispensing device, a mould that includes at least two half-moulds wherein at least one of said half-moulds is movable towards the other so as to compression mould an object from the dose and at least one transport element, suction means and blowing means. The transport element includes a pushing element, provided with a contact surface, and a transport surface.

The invention relates to an apparatus for producing, by compression moulding, concave objects, in particular containers.

The apparatus according to the invention may be used, for example, for producing capsules designed to contain a powdered or granular substance such as coffee or the like, for preparing beverages or other food product fluids. Alternatively, the apparatus according to the invention may be used for producing preforms designed to be subjected to blowing or stretching-blowing process to form containers such as bottles. More generally speaking, the apparatus according to the invention may be used for making containers of any type, such as, for example glasses, jars or bowls, or other concave objects such as caps for containers.

The apparatus according to this invention allows the production of concave objects made with a single material, starting from any polymeric material which can be subjected to compression moulding. Alternatively, the apparatus according to the invention allows the production of concave objects having a multilayer structure, that is to say, having a wall formed by two or more layers placed side by side made of polymeric materials different to each other.

There are prior art apparatuses for producing objects by compression moulding dosed quantities of polymeric material. The prior art apparatuses comprise an extruder for dispensing a polymeric material and a plurality of moulds, each of which comprises a male element equipped with a punch and a female element equipped with a cavity. The prior art apparatuses also comprise a plurality of transport elements, each of which transports a dose of polymeric material from the extruder to a mould.

In the moulds of the prior art apparatuses, for example, the female element is located beneath the male element, in such a way that the cavity of the female element faces upwards. The dose of polymeric material, after having been severed from the extruder, is released inside the cavity of the female element from the transport element, which makes the dose fall from the top towards the bottom of the cavity.

Alternatively, the male element is positioned beneath the female element in such a way that a punch of the male element faces upwards. The dose of polymeric material, after having been severed from the extruder, is released on the punch of the male element from the transport element.

Subsequently, the male element and the female element are moved towards each other to deform the dose, shaping it according to the desired geometry.

Although prior art apparatuses are able to operate in a satisfactory manner in a large number of cases, they have several drawbacks especially, but not exclusively, when it is necessary to compression mould multi-layer doses, that is to say, doses comprising a plurality of layers made from materials different to each other. In this case, positioning the dose correctly inside the mould is a particularly critical operation.

In certain cases, the prior art apparatuses can produce defective objects because the dose has not been correctly positioned in the mould.

Moreover, it is possible that due to the temperatures reached by the dose of polymeric material, it has a consistency such that it does not sever from the transport element or that part of the dose remains attached to the transport element, thus resulting in the formation of objects with reduced thicknesses or with non-uniform distributions of the material.

The technical purpose of the invention is therefore to provide an apparatus which is able to overcome the drawbacks of the prior art.

An object of the invention is therefore to provide an apparatus for compression moulding doses comprising at least one polymeric material, wherein each dose can be correctly positioned inside the mould.

A further object of the invention is to provide an apparatus wherein there is not the risk that the dose remains attached, even only partly, to the transport element.

The technical purpose indicated and the objects specified are substantially achieved by an apparatus comprising the technical features described in one or more of the appended claims. The dependent claims correspond to possible embodiments of the invention.

The invention comprises an apparatus comprising:
a dispensing device for dispensing at least one polymeric material;
a severing element for severing a dose of polymeric material from the polymeric material dispensed by the dispensing device;
a mould comprising two half-moulds wherein at least one of the half-moulds is movable towards the other so as to compression mould an object from the dose;
at least one transport element, movable along a closed path defined between the dispensing device and the mould, configured for picking up the dose from the dispensing device and then releasing the dose into the mould;
suction means and blowing means connected or connectable to said transport element and selectively activatable, respectively, for retaining or releasing the dose,

The transport element is configured to perform a rotary movement about a relative axis, transversal to the closed path, for rotating between a first orientation, with which the dose is received by the transport element, to a second orientation with which the dose is released on the mould.

The transport element comprises a pushing element comprising a contact surface.

The transport element also comprises a transport surface designed to define a contact with the dose and defined by the contact surface and by a surface surrounding the transport element which surrounds the pushing element.

The pushing element is movable between a retracted position, wherein the contact surface is positioned flush with the surrounding surface, and a protruding position wherein the contact surface protrudes relative to the surrounding surface to release the dose into the mould.

The pushing element comprises, on the contact surface, a plurality of passage holes connected or connectable to the suction means and to the blowing means in such a way as to define, selectively, the fluid communication between the dose and the suction means, for retaining the dose, or the blowing means, for releasing the dose.

Thanks to the invention, it is possible to position more correctly the dose in the mould with respect to that which occurred in the prior art. In effect, the transport element, turning the dose from the first orientation to the second orientation, makes it possible to face the dose to the mould and, by the combined intervention of the pushing element and of the blowing means, to deliver the dose to the mould.

According to an aspect of the invention, the two half-moulds are, respectively, a male mould element and a female mould element.

The transport element, by means of the pushing element and the blowing means, is therefore able to release the dose in the male mould element reducing the risks that the dose is positioned in an off-centre or asymmetrical manner inside the mould.

Moreover, since the dose is released on the male mould element, the portion of the dose which touches firstly the mould is that which is in contact with the male mould element, and is therefore intended to form the inner surface of the object moulded. In this way, there is no risk of having marks, due to the cooling of the dose, on the outer surface of the moulded object, thus improving the quality of the object.

The male mould element has an upper surface, that is to say, a supporting zone. The upper surface is substantially horizontal.

In the second position, the transport element, that is to say, the dose, lies on a substantially horizontal plane and the pushing element is therefore also configured to move vertically towards the mould.

This prevents the dose from being positioned in an inclined position, which could lead to a non-uniform filling of the mould.

In an alternative version, the dispensing device may comprise a co-extrusion device for dispensing a continuous multilayer co-extruded structure, comprising at least two layers of different materials.

In one version, the apparatus comprises at least one severing element for severing a dose of polymeric material from the polymeric material dispensed by the dispensing device.

The severing element may be supported by the transport element.

Alternatively, the severing element may be located upstream of the transport element and severed from the transport element.

In one version, the severing element is configured to sever doses having a parallelepiped shape from a continuous structure dispended by the dispensing device.

The doses having a parallelepiped shape are particularly easy to obtain, simply by cutting a flat extruded piece, without generating waste.

Moreover, the doses having a parallelepiped shape are delimited by flat faces. More specifically, a face of the dose designed to rest on the male mould element is in this case flat. It is thus possible to obtain a good stability in the positioning of the dose on the male mould element, even though the latter is by definition free of side walls.

The stability in positioning the dose on the male mould element is further increased if the latter is delimited above by a transversal surface defining a flat zone for supporting the dose.

Further features and advantages of the invention are more apparent in the non-limiting description which follows of a non-exclusive embodiment of an apparatus for producing, by compression moulding, concave objects, in particular containers.

The description is set out below with reference to the accompanying drawings which are provided solely for purposes of illustration without restricting the scope of the invention and in which:

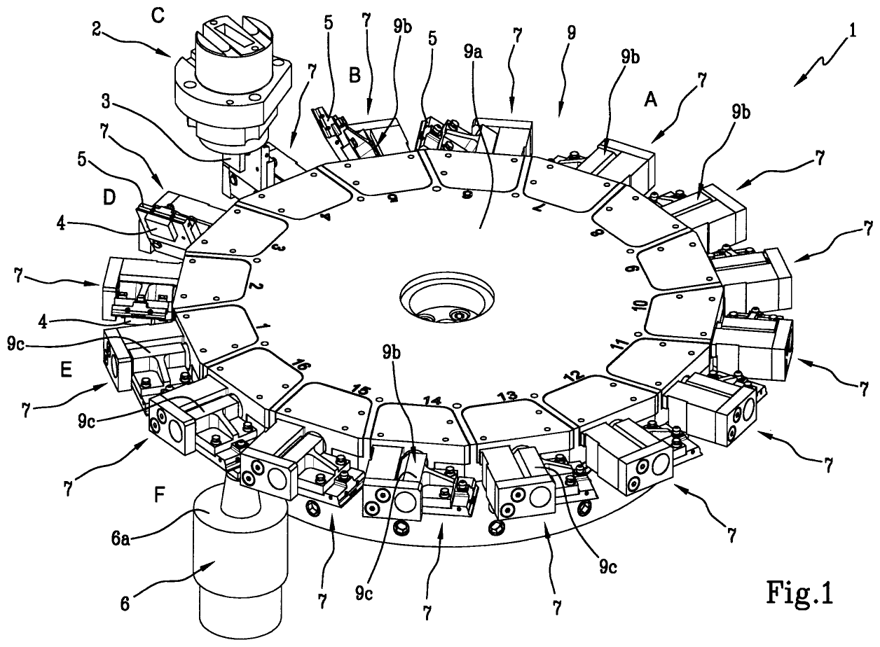

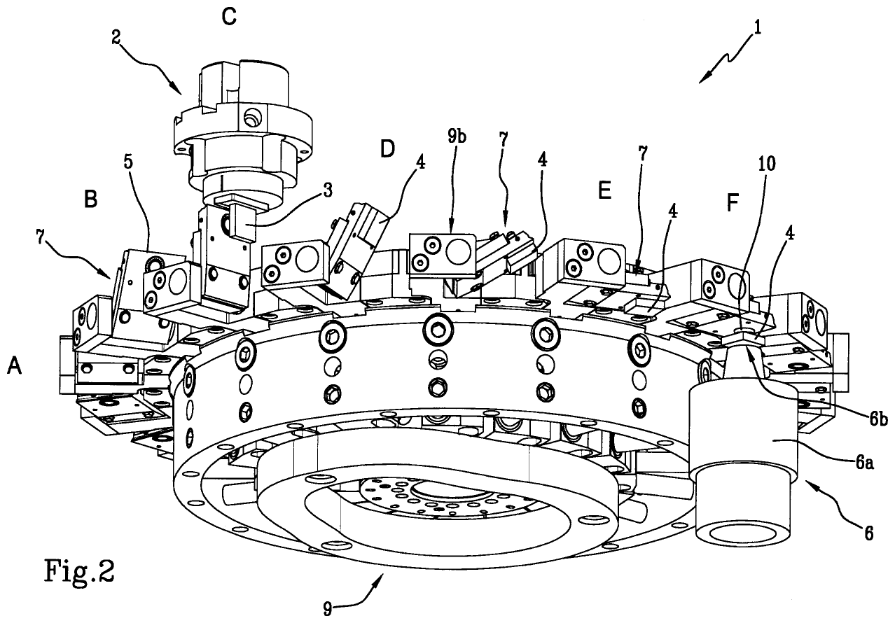

FIGS. 1 and 2 are perspective views of the apparatus according to the invention;

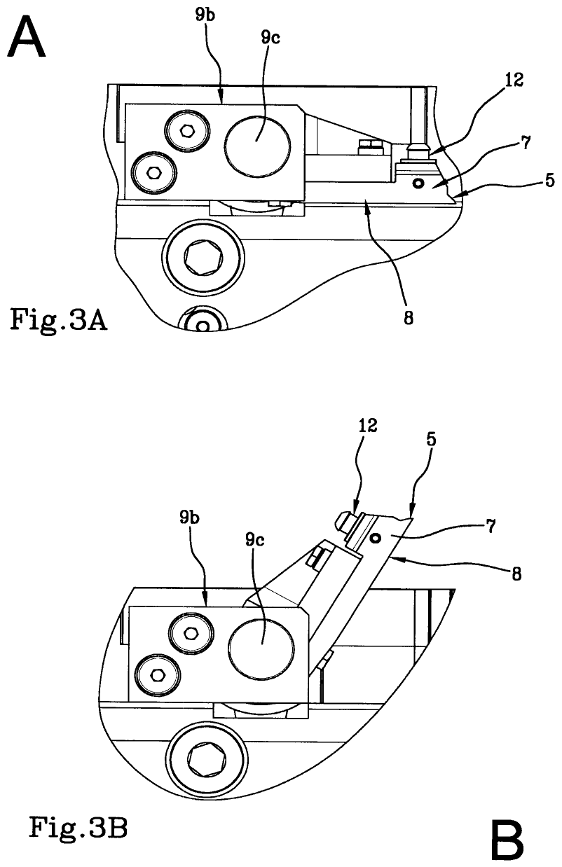

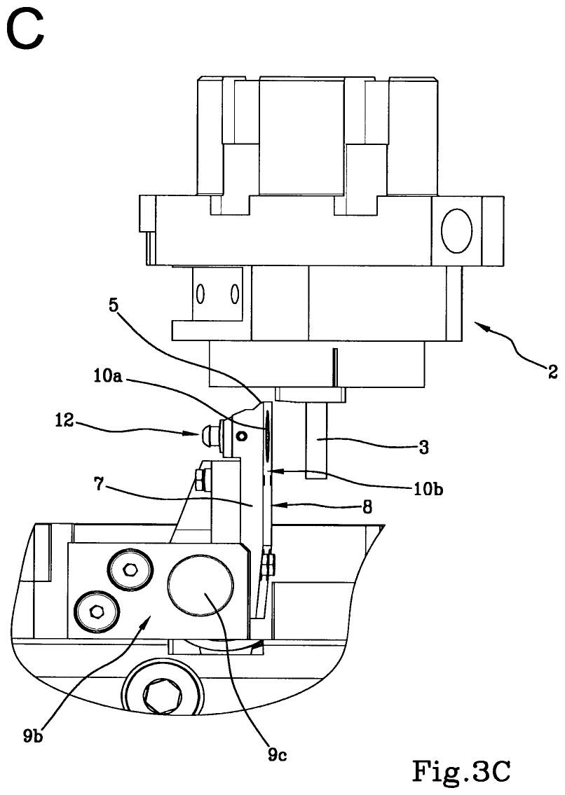

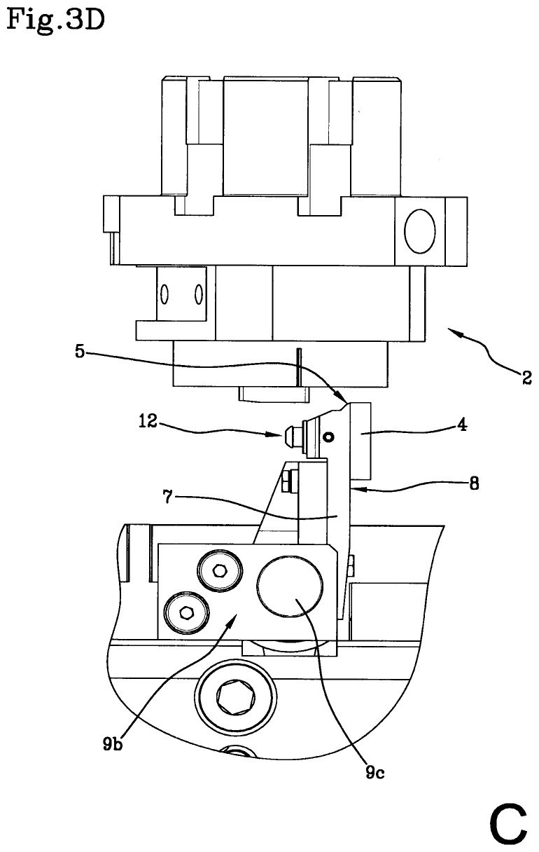

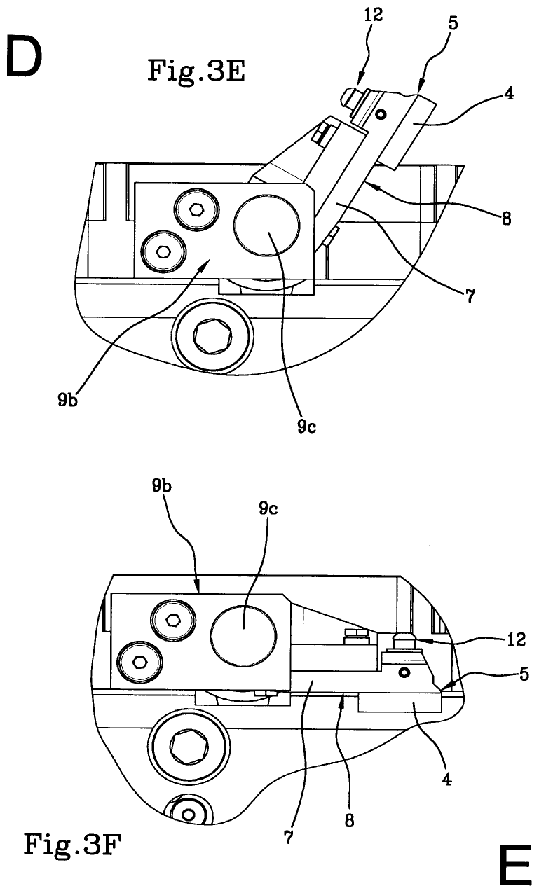

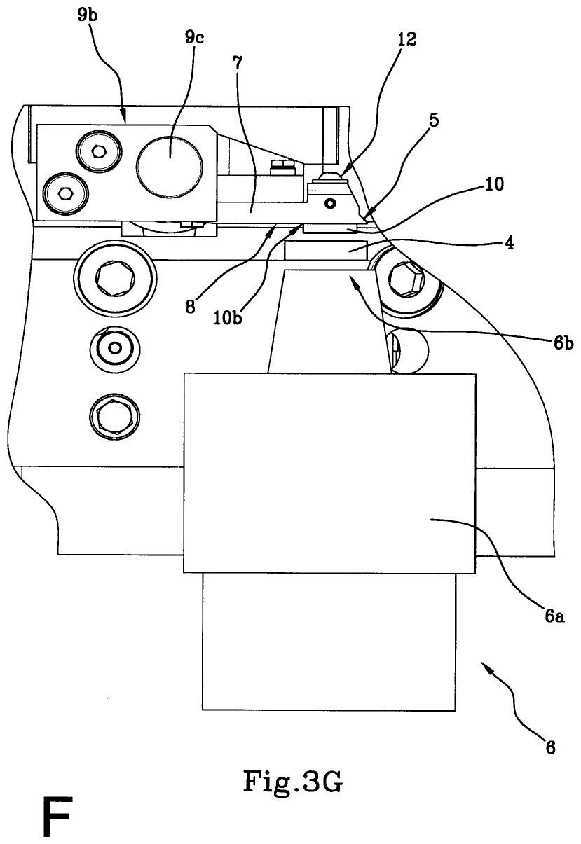

FIGS. 3A-3G are details of the apparatus of FIG. 1 and FIG. 2, representing various processing steps in the apparatus;

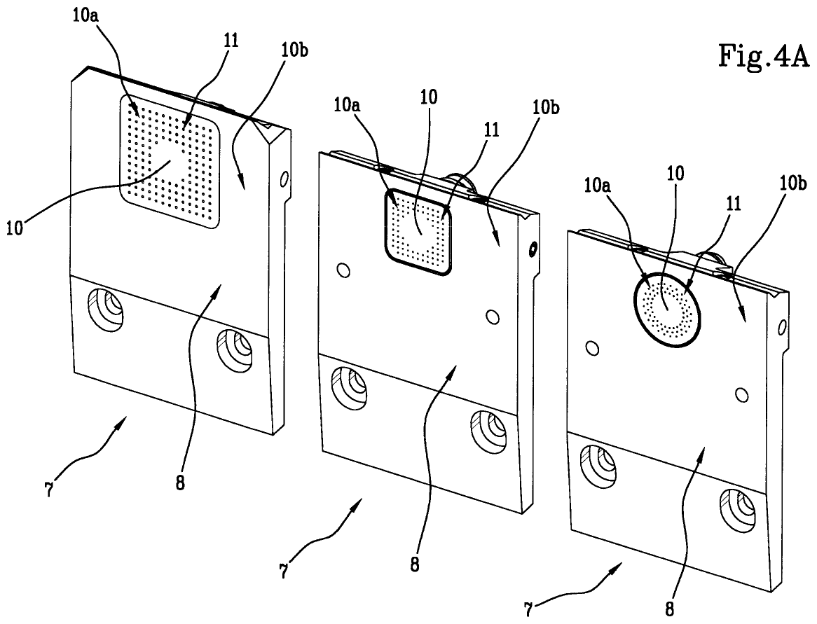

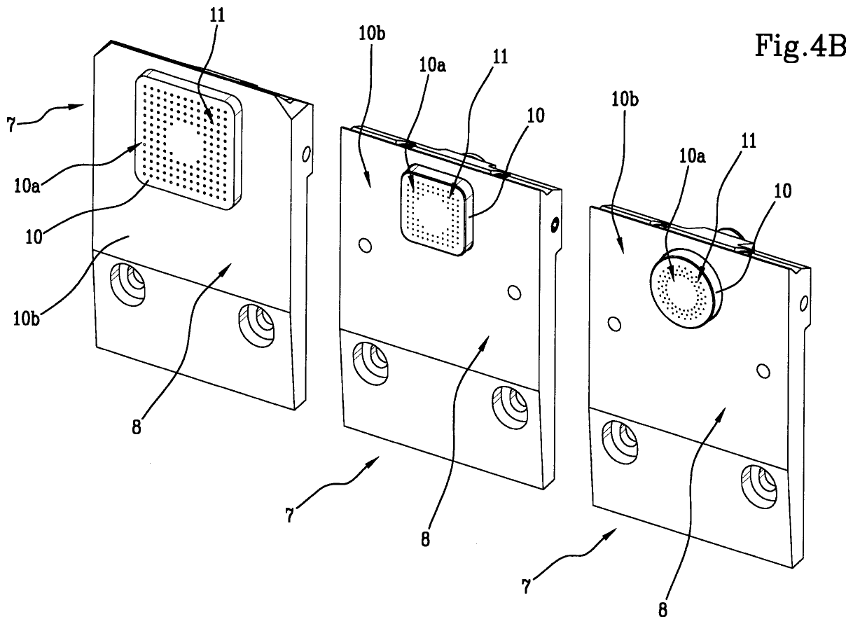

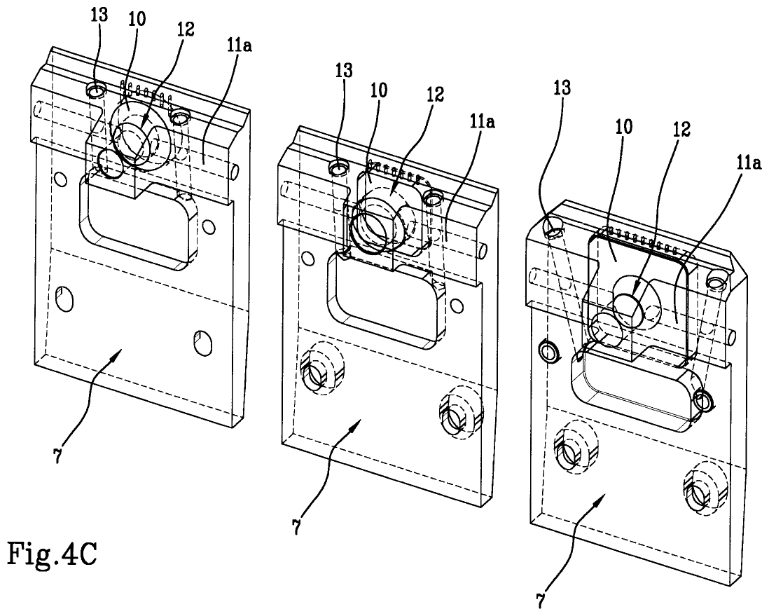

FIGS. 4A-4C are schematic representations of a component of the apparatus according to the invention;

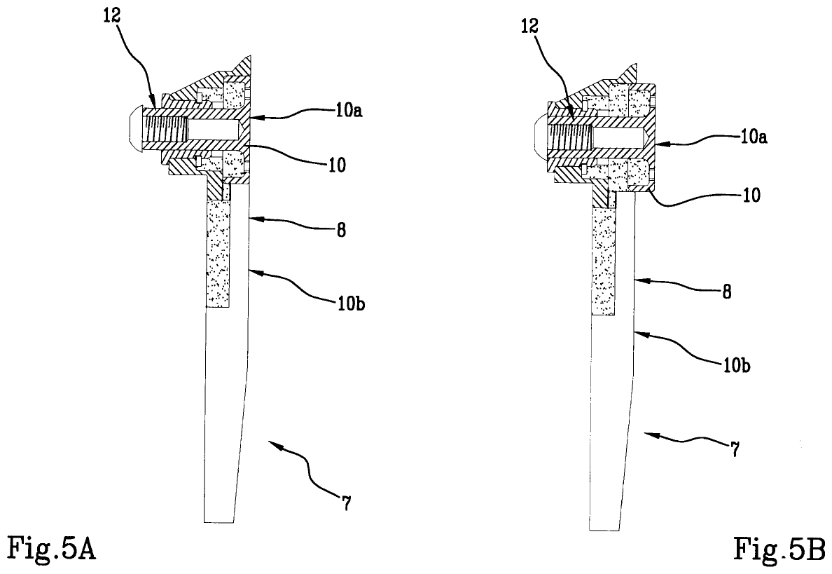

FIGS. 5A and 5B are schematic cross sections of the component of FIGS. 4A-4C.

With reference to the accompanying drawings, the numeral 1 denotes in its entirety the apparatus for producing, by compression moulding, concave objects, in particular containers.

The term containers may mean, for example, capsules for coffee or other substances containing ingredients which can be extracted by means of a fluid, or jars, glasses or bowls. Alternatively, the apparatus 1 may be used for producing preforms intended to form containers by blow-moulding. It is also possible to use the apparatus 1 for producing caps for containers.

The apparatus 1 comprises a dispensing device 2 for dispensing at least one polymeric material. For example, the dispensing device 2 can comprise a co-extrusion device for dispensing a continuous coextruded structure 3 comprising a plurality of layers of polymeric materials different to each other. In other words, the dispensing device 2 may be configured for dispensing a single material polymeric material, that is to say, made with a single polymeric material, or a multilayer polymeric material, that is to say, formed by several layers placed side by side made with polymeric materials different to each other.

The dispensing device 2 is equipped with an outlet opening having a rectangular or square shape, so as to dispense a continuous structure shaped like a strip having a cross-section which is rectangular or square. If the transversal cross section of the strip is rectangular, the base of the rectangle may be much greater than the height, even if this condition is not necessary. According to the accompanying drawings, the outlet opening faces downwards in such a way as to dispense a continuous structure 3 downwards, along a vertical or substantially vertical outlet direction. However, this condition is not necessary.

In other words, the dispensing device 2 is configured for dispensing a dose 4 having the shape of a parallelepiped.

According to a version not illustrated, the outlet opening can have shapes different from the rectangular or square shape, so as to dispense continuous structures having other types of transversal cross-section, for example a cylindrical cross-section.

The apparatus 1 also comprises a severing element 5 for severing a dose 4 of polymeric material (that is to say, the continuous structure 3) from the polymeric material dispensed by the dispensing device 2.

According to the example shown there is a plurality of severing elements 5. Alternatively, the severing element 5 may be made close to the outlet opening and can be operated in such a way as to sever the dose 4 from the continuous structure 3.

The apparatus 1 also comprises a mould 6 comprising two half-moulds wherein at least one of the two half-moulds is movable towards the other so as to compression mould an object from the dose 4. Preferably, the mould 6 may mean a structure made or which can be made like a carousel provided with a plurality of half-moulds.

Preferably, the two half-moulds can be made as a female mould element and a male mould element 6a aligned with each other along a moulding axis which may, as shown for example in the accompanying drawings, be vertical.

The male mould element 6a may be shaped like a punch and is positioned to form an inner surface of an object, for example a coffee capsule. The male mould element 6a may be positioned beneath the female mould element which therefore has a moulding cavity facing downwards.

According to an alternative version not illustrated, the male mould element may be positioned above the female mould element.

In the version illustrated, the punch of the male mould element 6a has a flat supporting zone 6b for the dose 4.

The apparatus 1 comprises at least one transport element 7 configured for picking up the dose from the dispensing device 2 and, subsequently, releasing the dose into the mould 6.

The transport element 7 is movable along a closed path defined between the dispensing device 2 and the mould 6.

Preferably, the transport element 7 is made in the form of a blade.

Preferably, and as shown in the accompanying drawings, the apparatus 1 comprises a plurality of transport elements 7 movable in succession along the closed path between the dispensing device 2 and the mould 6.

Preferably, and as shown in the accompanying drawings, the severing element 5 is included or defined on an end for picking up the dose 4 of the transport element 7.

Each severing element 5 is associated with a respective transport element 7 and is in particular supported by the transport element 7. For example, each severing element 5 may be shaped like a cutting edge which delimits a transport surface 8.

According to this embodiment, the transport element 7 is therefore made in the form of a blade.

The transport element 7 is also configured to perform a rotary movement about a relative axis, transversal to the closed path, for rotating between a first orientation and a second orientation.

According to the first orientation, shown in FIGS. 3C and 3D, the dose 4 is received by the transport element 7. According to the accompanying drawings, the first orientation is substantially vertical in accordance with the outlet direction of the continuous structure 3 from the dispensing device 2. Alternatively, if the dispensing device 2 does not dispense the material with a vertical orientation, the first orientation would also not be vertical.

According to the second orientation, shown in FIGS. 3A, 3F and 3G, the dose 4 is released on the mould 6. According to the accompanying drawings, the second orientation is substantially horizontal in accordance with the upper surface, that is, the supporting zone 6b, of the male mould element 6a.

Preferably and as shown in FIGS. 1 and 2, the apparatus 1 comprises a transport device 9 provided with a central support 9a, rotatable about a relative axis and configured for moving the at least one transport element 7 along the closed path. The transport device 9 is also provided with means for modifying the orientation 9b configured for moving the transport element 7 between the first orientation and the second orientation.

The central support 9a is configured for supporting a plurality of transport elements and the means 9b for modifying the orientation are configured for selectively moving each transport element 7 between the first orientation and the second orientation along the closed path when a respective transport element 7 is close to the dispensing device 2 or the mould 6.

In other words, the transport element 7 is configured for modifying a relative orientation during the movement along the closed path.

Each transport element is connected to an arm 9c supported by the central body 9a and the means 9b for modifying the orientation are configured for rotating each transport element 7 about the arm 9c coinciding with the axis of rotation of the transport element 7.

For this reason, the transport device 9 is configured to move the transport elements 7 along a path directed from a pickup position (wherein the dispensing device 2 is present and the transport element 7 picks up the dose 4) and a release position (wherein the mould 6 is present and the transport element 7 releases the dose 4 in the mould 6). In this context, the means for modifying the orientation 9b are configured for modifying the orientation of the dose 4 preferably in the second half of the closed path from the pick up position to the release position. In the accompanying drawings, the axis of rotation of the central body 9a is parallel to the moulding direction of the mould 6.

The apparatus 1 also comprises suction means and blowing means connected or connectable to the transport element 7 and selectively activatable, respectively, for retaining or releasing the dose 4.

In other words, the suction means are configured for retaining the dose 4 on the transport element 7 whilst the blowing means are configured for releasing the dose 4.

Preferably, the suction means can be made in the form of a vacuum source.

Preferably, the blowing means can be made in the form of a source of compressed air.

The transport element 7 further comprises a pushing element 10, provided with a contact surface 10a, and a transport surface 8 designed to define a contact with the dose 4 and defined by the contact surface 10a and by a surrounding surface 10b of the transport element 7 which surrounds the pushing element 10.

The pushing element 10 is movable between a retracted position (for example shown in FIG. 4A) and a protruding position (for example shown in FIG. 4B).

In the retracted position, the contact surface 10a is positioned flush with the surrounding surface 10b, thus defining the transport surface 8. This configuration is suitable for picking up and transporting the dose 4.

In the protruding position, the contact surface 10a protrudes relative to the surrounding surface 10b (that is, to the transport surface 8) for releasing the dose 4 into the mould 6.

Preferably, pushing element 10 is made in the form of a piston defining a contact surface 10a having a circular or square shape.

The transport surface 8 is sized in such a way that the dose 4 adheres to the transport surface 8 for minimising the deformation of the dose 4 (single layer or multilayer) during the transport.

Preferably, the transport surface 8 is sized in such a way as to have an area greater than the face of the dose 4.

Preferably, the contact surface 10a is sized in such a way as to have an area less than the face of the dose 4, in such a way as to facilitate a pushing action and detachment of the dose 4 from the transport surface 8.

The pushing element 10 is therefore a mechanical element which, at the suitable moment, pushes the dose 4 downwards (in the configuration of the accompanying drawings) helping it to detach from the transport surface 8 to be released into the mould 6.

The pushing element 10 comprises on the contact surface 10a a plurality of passage holes 11 connected or connectable to the suction means and to the blowing means and configured to selectively establish a fluid communication between the dose and the suction means or the blowing means.

Preferably, the plurality of holes 11 is distributed on a perimeter portion of the contact surface 10a, as shown in FIGS. 4A and 4B.

Alternatively, the plurality of holes 11 is distributed over the entire contact surface 10a.

In this context, by means of the passage holes 11, the suction means are configured to prevent detachment of the dose 4 from the transport surface 8. In other words, the suction means are configured to retain the dose 4 in contact with the transport surface 8 during the path from the pickup position to the release position.

For example, a plurality of passage holes 11 open onto the contact surface 10a, in order to establish a fluid communication between the dose 4 which interacts with the transport surface 8 and a vacuum source.

Again in this context, by means of the passage holes 11, the blowing means are configured for easily detaching the dose 4 from the surface when the transport element 7 is in the release position. In other words, the combined movement of the pushing element 10 and the action of the blowing means through the passage holes 11 guarantee the correct detachment of the dose 4 from the transport element as well as the correct positioning of the dose 4 on the mould 6.

For example, the blowing means may comprise a source of compressed air, configured for detaching the dose 4 from the transport surface 8 by means of the passage holes 11.

For this reason, the passage holes 11 are connected to the vacuum source when the transport element 7 is about to pick up or has just picked up a dose 4 from the dispensing device 2 in such a way that the dose 4 remains anchored without undergoing unwanted deformations and, subsequently, they are connected to the source of compressed air when the transport element 7 is facing the mould 6 and the pushing element 10 is in the protruding position. In other words, the transport element 7 allows an easier detachment of the dose 4 from the transport surface 8, when necessary, so that the dose 4 can be delivered to the mould 6.

For this reason, as shown in FIG. 4C, the transport element 7 is provided inside with special inner ducts 11a, positioned in communication with the suction and/or blowing means with the passage holes 11, used or which can be used for the suction or blowing of the air.

Preferably, the suction means and the blowing means are also in communication with a mechanism 12 for moving the pushing element 10 and which can be selectively activated for moving the pushing element 10 between the retracted position and the protruding position.

In other words, the movement of the pushing element 10 occurs by means of the above-mentioned movement mechanism 12 which can be activated by suitable control or by means of suction or blowing means.

Preferably, the movement mechanism 12 consists in a guide in which a portion of the pushing element 10 can slide. In particular, the actuation using the blowing means (or the suction means) occurs by the interaction of the latter with an inner surface of the pushing element 10 causing the movement between the retracted position and the protruding position.

In other words, the blowing means introduce air against the inner wall of the pushing element 10 pushing it from the retracted position (FIG. 5A) to the protruding position (FIG. 5B).

Similarly, the action applied by the suction means generates a force on the contact surface 10a which causes a further sliding of the pushing element 10 in the relative guide, returning it to the retracted position (FIG. 5A).

For this reason, according to this embodiment, the retracted position of the pushing element 10 derives from the suction means (that is, the vacuum source) which, by sucking air, retains the dose 4 against the transport surface 8 and keeps the pushing element 10 (that is, the contact surface 10a) flush with the surrounding surface 10b as shown in FIG. 5A.

Similarly, the protruding position of the pushing element 10 derives from the blowing means (that is, the source of compressed air) which, by blowing air, releases the dose 4 from the transport surface and keeps the pushing element 10 (that is, the contact surface 10a) spaced from the surrounding surface 10b as shown in FIG. 5B.

Preferably, the inner ducts 11a may be used to put the suction or blowing means in communication with the movement mechanism 12 in such a way as to obtain, by actuating the respective means, both the retaining or blowing of the dose 4 and the movement of the pushing element 10.

Preferably, the transport element 7 is provided with thermal conditioning means for thermally conditioning the dose 4 during transport and/or the transport element 7 along the closed path.

Advantageously, the thermal conditioning means may be used to prevent the dose 4 from excessively cooling or overheating.

Preferably, the thermal conditioning means may comprise or be shaped like heating means to prevent an excessive cooling the dose 4 during transport which could result in a non-optimum compression during the formation of the object in the mould 6.

Alternatively, the thermal conditioning means may comprise or be designed like cooling means to prevent an excessive adhesion of the dose 4 to the transport element 7, if the transport element tends to overheat.

Preferably, the thermal conditioning means comprise an inner duct 13 surrounding the pushing element 10 and placed in fluid communication with a source of air or water.

Preferably, the blowing means and the suction means comprise the thermal conditioning means. In other words, the suction and blowing means can be activated selectively and used for adjusting the temperature of the transport element 7 during its movement during the closed path.

For example, after the release of the dose 4 in the mould 6, the suction means can be activated both to recall the pushing element 10 and to cool the transport element 7 in such a way as to reduce a temperature after contact with the dose 4.

With reference to the accompanying drawings, and in particular FIGS. 1, 2, 3A-3G, the letters “A, B, C, D, E, F” denote in their entirety various operating steps of the apparatus 1 according to the invention.

FIG. 3A shows step “A”, identifying the position adopted by a transport element 7 in the closed portion of path defined between the mould 6 and the dispensing device 2.

During this step, the transport element 7 adopts a substantially flat configuration and is free of the dose 4 to be transported.

Preferably, during step “A” the pushing device 10 is located in the retracted position. Alternatively, the pushing device 10 may be located in the protruding position but, before entering into contact again with the dose 4, it must be again located in the retracted position.

Preferably, the thermal conditioning means may be active during the step “A”, in order to adjust a temperature of the transport element 7 previously altered by the temperature of the dose 4.

During the step “A”, if the thermal conditioning means coincide with the suction or blowing means, it is possible to actuate the means in order to suck air or blow air from the passage holes 11 at a temperature suitable for obtaining the desired adjustment.

FIG. 3B shows the step “B” which represents a configuration adopted by the transport element 7 when approaching the dispensing device 2. In particular, a rotation of the transport element 7 starts in the proximity of the dispensing device 2 suitable for positioning it from the second to the first orientation. Preferably, in this step “B” the means for modifying the orientation 9b are activated which place the transport element 7 in rotation relative to its axis of rotation, that is, about the arm 9c which connects the transport element 7 to the central body 9a of the transport device 9.

FIGS. 3C and 3D show the step “C” identifying the engaging of the transport element 7 with the dose 4.

In particular, FIG. 3C shows the dispensing device 2 during the release of the continuous structure 3 of polymeric material whilst the transport element 7 is in a substantially vertical position and towards the continuous structure 3.

FIG. 3D shows, on the other hand, the transport element 7, again in a vertical position, designed to transport the dose 4 obtained from the continuous structure 3.

The actual engaging of the dose 4 with the transport element 7 occurs between FIG. 3C and FIG. 3D. In particular, during this engagement the severing element 5 intervenes, which in the accompanying drawings is defined on the transport element 7, which severs the dose 4 from the continuous structure 3. During the “cutting” of the dose 4 from the structure 3, the dose 4 comes into contact with the transport surface 8, that is to say, with the contact surface 10a and part of the surrounding surface 10b. During this engaging the suction means are also activated in order to guarantee the retaining of the dose 4 on the transport surface 8.

FIG. 3E shows, on the other hand, the step “D” which represents a configuration adopted by the transport element 7 when moving away from the dispensing device 2 and before moving towards the mould 6. More specifically, the transport element 7 starts a rotation suitable for positioning it from the first orientation to the second orientation. The suction means are active during this movement. Preferably, in this step “D” the means for modifying the orientation 9b are activated which place the transport element 7 in rotation relative to its axis of rotation, that is, about the arm 9c which connects the transport element 7 to the central body 9a of the transport device 9.

FIG. 3F shows, on the other hand, the step “D” identifying the second orientation adopted by the movement element 7 before reaching the mould 6. During this step both the transport element 7 and the dose 4 have a substantially horizontal orientation and the suction means guarantee the retaining of the dose 4 preventing accidental falling.

Lastly, FIG. 3G shows the step “F” identifying the release of the dose 4 in the mould 6. During this step, the pushing element 10 is actuated in such a way as to sever the dose 4 from the transport surface 8, that is to say, from the surrounding surface 10b. After or simultaneously with the pushing movement, wherein the pushing element 10 is placed from the retracted position to the protruding position, the suction means are deactivated and the blowing means are actuated in such a way as to detach the dose 4 also from the contact surface 10a.

In other words, the pushing element 10 moves the dose 4 towards the mould 6 (in particular to the supporting zone 6b of the male mould element 6a) and the blowing means perform the actual detachment of the dose 4 and the release in the mould 6 (that is, the resting on the upper surface, that is, the supporting zone 6b, of the male mould element 6a).

Advantageously, the apparatus 1 described above is able to overcome the drawbacks of the prior art.

The joint action of the pushing element 10 with the blowing means allows a secure release of the dose 4 in the mould 6 to be obtained. With reference to the accompanying drawings, the pushing element 10 and the blowing means allow a secure release of the dose 4 on the supporting zone 6b of the mould 6 to be obtained.

Advantageously, the pushing element 10 performs a first movement of the dose 4 towards the mould 6 which guarantees, once it is released, that changes of trajectory or too abrupt landing of the dose 4 on the mould 6 is avoided, which could define non-optimum centring of the dose. In other words, the correct positioning of the dose 4 in the mould 6 allows a forming to be obtained by compression of the object which is more uniform and precise, thus obtaining objects of the desired quality.

Moreover, according to the version illustrated, since the dose 4 is deposited on a supporting zone 6b of a male mould element 6a, the pushing element 10 and the blowing means guarantee that the formation of undesired marks on the outer portion of the object to be formed is prevented.

1. An apparatus (1) comprising:
a dispensing device (2) for dispensing at least one polymeric material;
a severing element (5) for severing a dose (4) of polymeric material from the polymeric material dispensed by the dispensing device (2);
a mould (6) comprising at least two half-moulds wherein at least one of said half-moulds is movable towards the other so as to compression mould an object from said dose (4);
at least one transport element (7), movable along a closed path defined between the dispensing device (2) and the mould (6), configured for picking up the dose (4) from the dispensing device (2) and, subsequently, releasing the dose in the mould (6), said transport element (7) being configured to perform a rotational movement about its own axis, transversal to said closed path, for rotating between a first orientation, with which the dose (4) is received by the transport element (7), and a second orientation with which the dose (4) is released into the mould (6);
suction means and blowing means connected or connectable to said transport element (7) and selectively activatable, respectively, for retaining the dose on the transport element (7) or releasing the dose (4) into the mould (6),
said transport element (7) comprising a pushing element (10), provided with a contact surface (10a), and a transport surface (8) designed to define a contact with the dose (4) and defined by the contact surface (10a) and by a surrounding surface (10b) of the transport element (7) which surrounds the pushing element (10),
wherein said pushing element (10) is movable between a retracted position, wherein the contact surface (10a) is positioned flush with the surrounding surface (10b), and a protruding position wherein the contact surface (10a) protrudes relative to the surrounding surface (10b) to release the dose (4) into said mould (6);
said pushing element (10) comprising, on said contact surface (10a), a plurality of passage holes (11) connected or connectable to the suction means and to the blowing means in such a way as to define, selectively, a fluid communication between the dose (4) and said suction means, for retaining the dose (4), or said blowing means, for releasing the dose (4).

2. The apparatus (1) according to claim 1, wherein said suction means and said blowing means are also in communication with a mechanism (12) for moving the pushing element (10) and which can be selectively activated to move said pushing element (10) between said retracted position and said protruding position.

3. The apparatus (1) according to claim 1, wherein the transport element (7) is provided with thermal conditioning means for thermally conditioning the dose (4) during transport and/or the transport element (7) along the closed path.

4. The apparatus (1) according to claim 3, wherein said thermal conditioning means are defined by an inner duct (13) surrounding said pushing element (10) and placed in fluid communication with a source of air or water.

5. The apparatus (1) according to claim 3, wherein said suction means and said blowing means comprise said thermal conditioning means.

6. The apparatus (1) according to claim 1, wherein said plurality of passage holes (11) is distributed on a perimeter portion of the contact surface (10a).

7. The apparatus (1) according to claim 1, wherein said severing element (5) is included or defined on an end for picking up the dose (4) of the transport element (7).

8. The apparatus (1) according to claim 1, wherein said transport element (7) is made in the form of a blade or a knife.

9. The apparatus (1) according to claim 1, wherein said pushing element (10) is made in the form of a piston defining a contact surface (10a) having a circular or square shape.

10. The apparatus (1) according to claim 1, comprising a transport device (9) provided with a central support (9a), rotatable about its own axis and configured for moving said at least one transport element (7) along said closed path, and means for modifying the orientation (9b) configured for moving said transport element (7) between the first orientation and the second orientation.

11. The apparatus (1) according to claim 10, wherein said central support (9a) is configured for supporting a plurality of transport elements (7) and said means (9b) for modifying the orientation are configured for selectively moving each transport element (7) between the first orientation and the second orientation along the closed path when a respective transport element (7) is close to the dispensing device (2) or said mould (6).

12. The apparatus (1) according to claim 10, wherein each transport element (7) is connected to an arm (9c) supported by the central body (9a) and the means (9b) for modifying the orientation are configured for rotating each transport element (7) about said arm (9c) coinciding with the axis of rotation.

13. The apparatus (1) according to claim 1, wherein said dispensing device (2) is configured for dispensing a dose (4) which is parallelepiped in shape and wherein one of said half-moulds has an upper end delimited by a substantially flat zone (6b) for supporting the dose (4).
